(19) United States
(12) Patent Application Publication
(10) Pub. No.: US 2015/0058224 A1
(43) Pub. Date: Feb. 26, 2015

(54) Mechanism For Secure In-Vehicle Payment Transaction

(71) Applicants: Ajit Gaddam, Sunnyvale, CA (US); Gyan Prakash, Foster City, CA (US); Selim Aissi, Menlo Park, CA (US)

(72) Inventors: Ajit Gaddam, Sunnyvale, CA (US); Gyan Prakash, Foster City, CA (US); Selim Aissi, Menlo Park, CA (US)

(21) Appl. No.: 14/466,405

(22) Filed: Aug. 22, 2014

Related U.S. Application Data
(60) Provisional application No. 61/869,257, filed on Aug. 23, 2013.

(51) Int. Cl. G06Q 20/32; G06Q 20/40; G06Q 20/10

(52) U.S. Cl. CPC G06Q 20/327; G06Q 20/10; G06Q 20/322; G06Q 20/40
USPC 705/44; 705/39

(57) ABSTRACT

Embodiments use a vehicle as a payment instrument to complete a payment transaction. A vehicle interface device (VID) coupled to the vehicle is used for transmitting payment account information to a merchant access device. The VID may be registered to the specific vehicle identification number (VIN) of the vehicle. Prior to transmitting the payment account information to the merchant access device, the VID may ensure that a mobile communication device is within the vehicle and/or that the VID is coupled to the correct vehicle. For example, the VID may compare the VIN of the vehicle to the VIN that is programmed to the VID. When the colocation of the VID with the mobile communication device and/or the correct vehicle is confirmed, the VID may forward payment account information to the merchant access device.

### CROSS-REFERENCES TO RELATED APPLICATIONS

This application claims benefit under 35 USC§119(e) to U.S. Provisional Patent Application No. 61/869,257 filed Aug. 23, 2013 and entitled “Mechanism for Secure In-Vehicle Payment Transaction”, the disclosure of which is incorporated by reference herein in its entirety for all purposes.

### BACKGROUND

An increasing number of consumers are using devices configured to use short range communication protocols for payment transactions. For example, a consumer's mobile device may comprise hardware for storing sensitive account information. In order to conduct a payment transaction, the consumer may place the mobile device in proximity to a point of sale terminal, access device, or other proximity or contactless communication reader. The transaction may then be processed using secure payment information stored on the consumer's mobile device, without the user requiring to provide a physical credit card or manually enter a credit card number.

Consumers may need to conduct payment transactions using short range communication protocols while they are in a vehicle. For example, a consumer may need to purchase food, gas or pay for tolls while driving. Even though current systems may allow for automatic toll payments, conventional payment systems do not allow for using vehicles for payments of goods or services, such as paying for food at a drive through restaurant using the consumer's vehicle. In addition, conventional systems do not verify the user information as long as a transponder is present within the vehicle. Accordingly, there is a need for allowing consumers to use their vehicles as payment instruments upon verifying that that the user of the vehicle (i.e. payment instrument) is the intended consumer of the payment account associated with the vehicle.

Embodiments of the present invention address these problems and other problems individually and collectively.

### BRIEF SUMMARY

Embodiments of the invention use a vehicle as a payment instrument to complete a payment transaction. A vehicle interface device (VID) coupled to the vehicle is used for transmitting payment account information to a merchant access device. The VID may have access to payment account information either by being directly coupled to a payment device or by having the payment account information stored in a memory of the VID. The VID may be registered to the specific vehicle identification number (VIN) of the vehicle. Prior to transmitting the payment account information to the merchant access device, the VID may ensure that a mobile communication device is within the vehicle and/or that the VID is coupled to the correct vehicle. For example, the VID may compare the VIN of the vehicle to the VIN that is programmed to the VID. When the colocation of the VID with the mobile communication device and/or the correct vehicle is confirmed, the VID may forward payment account information to the merchant access device.

One embodiment of the invention is directed to a method including receiving, at a vehicle interface device, a request for payment account information from an external device. The method also includes determining, by the vehicle interface device, that the vehicle interface device is located in a predetermined vehicle. The method includes determining, by the vehicle interface device, that a mobile communication device is located in the predetermined vehicle. The method further includes transmitting the transaction account information to the external device upon determining that the vehicle interface device and the mobile communication device are located in the predetermined vehicle.

Another embodiment is directed to an interface device comprising a processor and a computer readable medium coupled to the processor. The computer readable medium comprises code that, when executed on the processor, causes the processor to receive a request for payment account information from an external device. The code, when executed on the processor, further causes the processor to determine that the vehicle interface device is located in a predetermined vehicle, and determine that a mobile communication device is located in the predetermined vehicle. The code, when executed on the processor, further causes the processor to transmit the transaction account information to the external device upon determining that the vehicle interface device and the mobile communication device are located in the predetermined vehicle.

Yet another embodiment is directed to a method including receiving, at a vehicle interface device, a request for payment account information from an external device. The method also includes registering, with the vehicle interface device, a vehicle identification number (VIN) associated with a predetermined vehicle. The method further includes determining, by the vehicle interface device, that the registered VIN is associated with a vehicle within which the vehicle interface device is located. The method includes transmitting the payment account information to the external device upon determining that the registered VIN is associated with the vehicle within which the vehicle interface device is located.

These and other embodiments of the invention are described in further detail below.

### BRIEF DESCRIPTION OF THE DRAWINGS

FIG. 1 shows a system for using a vehicle as a payment instrument according to various embodiments.

FIG. 2 shows an exemplary vehicle interface device.

FIG. 3 shows a flowchart illustrating methods according to embodiments of the invention.

FIG. 4 shows a flowchart of a method for transmitting payment information using a vehicle interface device based on the presence of the mobile device, according to an exemplary embodiment.

FIG. 5 shows a flowchart of a method for transmitting payment information using a vehicle interface device based on the verification of a VIN, according to another exemplary embodiment.

FIG. 7 shows a block diagram of an exemplary financial transaction system.

FIG. 8 shows a block diagram of some components of a computer apparatus.

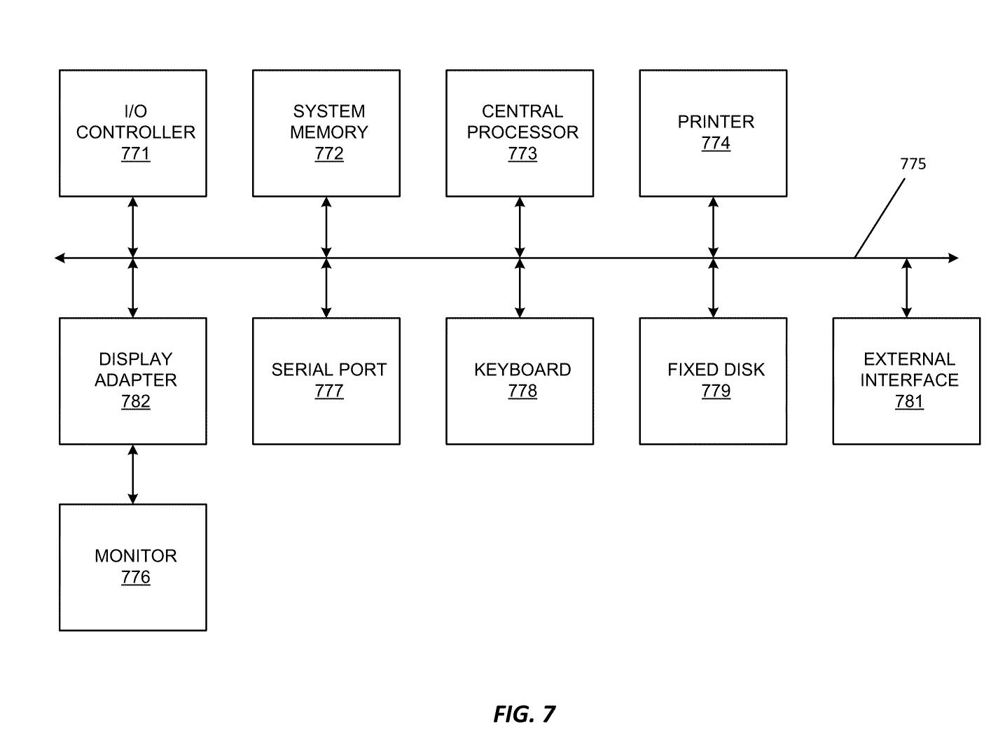

### DETAILED DESCRIPTION

Embodiments are directed at systems, methods, and devices for using a vehicle as a payment instrument to complete a payment transaction without having the user to leave the vehicle or hand over payment device to a third party. A vehicle interface device (VID) may be coupled to the vehicle. The VID may be registered to the specific vehicle identification number (VIN) of the vehicle. The VID may have access to payment account information either by being directly coupled to a payment device or by having the payment account information stored in a memory of the VID. Prior to transmitting the payment account information to a merchant access device, the VID may ensure that a mobile communication device is within the vehicle and/or that the VID is coupled to the correct vehicle. For example, the VID may compare the VIN of the vehicle to the VIN that is programmed to the VID. When the colocation of the VID with the mobile communication device and/or the correct vehicle is confirmed, the VID may forward payment account information to the merchant access device.

In some embodiments, the payment device may be a payment card, such as a credit card, a debit card or a prepaid card, that is coupled to the VID. For example, the VID may have a slot where the payment card may be inserted. The VID may read the payment account information such as the payment account number, expiration date, CVV, etc. directly from the payment card. Alternatively, the payment account information may be provided to the VID (e.g. entered by the user using input devices or transferred/uploaded from an e-wallet) and stored at a memory of the VID.

Embodiments of the invention have a number of advantages. For example, the present invention provides a three-factor security system by confirming the colocation of a specific mobile communication device, a specific vehicle with a specific VIN and a VID registered to the specific VIN. Accordingly, for a fraudulent transaction, all three objects need to be stolen at the same time. For example, no purchases may be made using the VID unless the corresponding vehicle and the mobile communication device were also present.

Using embodiments discussed herein, the user is able to make purchases without having to leave the car or handing an object (e.g., the payment device or the VID) out of the car. For example, the user would not need to pass the payment device to a merchant, and thereby the risk of unauthorized copying of payment account information is reduced and convenience is increased.

The systems and methods described herein comprise a seamless authentication. When the VID, the vehicle with a specific VIN, and the mobile communication device are present, the user does not need to re-enter payment account information, a password, the VIN or any other identification information for each transaction or otherwise perform any activity to achieve three factor security beside simply possessing the three coupled devices.

Prior to discussing embodiments of the invention, description of some terms may be helpful in understanding embodiments of the invention.

“Short range communication” or “short range wireless communication” may comprise any method of providing short-range contact or contactless communications capability, such as radio frequency identification (RFID), Bluetooth™, infra-red, near field communication (NFC), dedicated short range communication (DSRC) or other data transfer capability that can be used to exchange data between a payment device and an external device such as a POS (point of sale) terminal. In some embodiments, short range communications may be in conformance with a standardized protocol or data transfer mechanism (e.g., ISO 14443/NFC). Short range communication typically comprises communications at a range of less than 2 meters. In some embodiments, it may be preferable to limit the range of short range communications (e.g., to a range of less than 1 meter, less than 10 centimeters, or less than 2.54 centimeters) for security, technical, and/or practical considerations. For instance, it may not be desirable for a POS terminal to communicate with every payment device that is within a 2 meter radius because each of those payment devices may not be involved in a transaction, or such communication may interfere with a current transaction involving different financial transaction devices. Typically the payment device or the access device also includes a protocol for determining resolution of collisions (i.e., when two payment devices are communicating with the access device simultaneously). The use of short range communications may be used when the merchant and the consumer are in close geographic proximity, such as when the consumer is at the merchant's place of business.

A “mobile communication device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. A mobile device may comprise any suitable hardware and software for performing such functions, and may also include multiple devices or components (e.g. when a device has remote access to a network by tethering to another device—i.e. using the other device as a modem—both devices taken together may be considered a single mobile device). A mobile device may also comprise a verification token in the form of, for instance, a secured hardware or software component within the mobile device and/or one or more external components that may be coupled to the mobile device.

“Payment account information” may include any suitable information associated with an account (e.g. a payment account and/or payment device associated with the account). Such information may be directly related to the account or may be derived from information related to the account. Examples of payment account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment account information may also be used as authentication data.

A “payment device” may include any device that may be used to conduct a financial transaction, such as to provide payment account information to a merchant. A payment device may be in any suitable form. For example, suitable payment devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of payment devices include cellular phones, personal digital assistants (PDAs), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode.

A “payment account” (which may be associated with one or more payment devices) may include to any suitable payment account including a credit card account, a checking account, or a prepaid account.

“Transaction information” may include any suitable information associated with a financial transaction, such as a transaction amount, a merchant identifier for a merchant associated with the transaction, the volume of the transaction, information about the goods or services being purchased, the merchant location, and any other information that is related to the current transaction.

An “authorization request message” may include any suitable message requesting authorization for a transaction. It may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “payment account information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be any suitable message requesting authorization for a transaction. It can be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

Embodiments of the present invention described herein include multiple different embodiments that may be combined in any suitable manner, as one of ordinary skill in the art would recognize. For example, in the various embodiments described below, various different parties, payment devices, access devices, and transaction processors are described and specific flow diagrams are provided as examples. These examples are provided for illustration of the concepts of the present invention and are meant to be non-limiting. Accordingly, features from the various embodiments may be combined in any suitable manner in different configurations than are provided explicitly in each illustrative system described herein. Accordingly, just one example of the various combinations that could be provided according to some embodiments of the present invention is described in more detail below.

### I. Vehicle Interface Device

Provided below are descriptions of some devices (and components of those devices) that may be used in the systems and methods described above. These devices may be used, for instance, to receive, transmit, process, and/or store data related to any of the functionality described above. As would be appreciated by one of ordinary skill in the art, the devices described below may have only some of the components described below, or may have additional components.

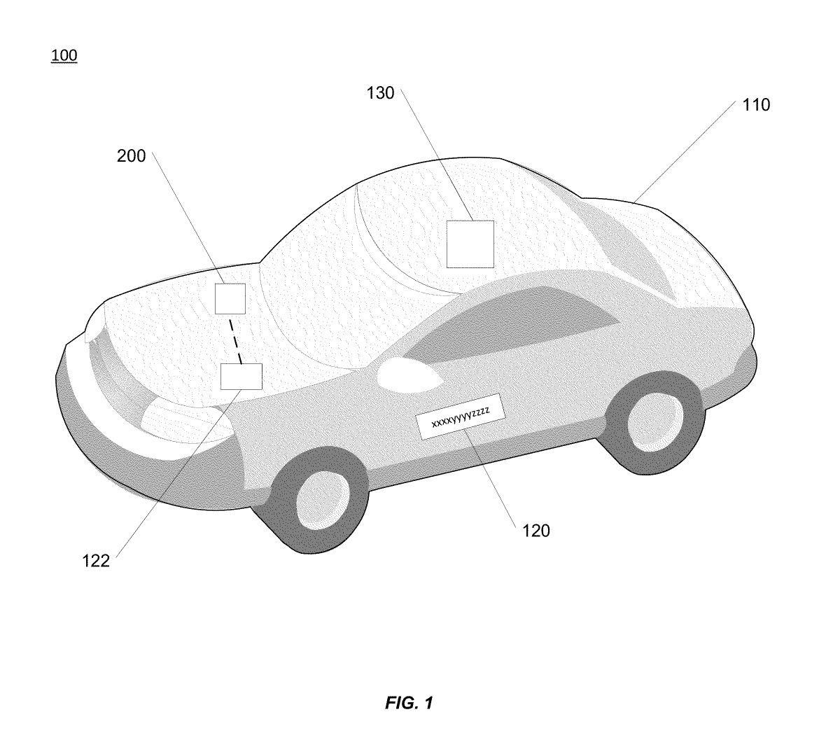

According to various embodiments of the present application a vehicle may be used as a payment instrument. A vehicle interface device (VID) may be coupled to the vehicle. The VID may be registered to the specific vehicle identification number (VIN) of the vehicle. The VID may have access to payment account information. Prior to transmitting the payment account information to a merchant access device, the VID may ensure that the VID is coupled to the correct vehicle and that a mobile communication device is within the vehicle. FIG. 1 illustrates an exemplary system 100 for using a vehicle as a payment instrument.

The system 100 illustrated in FIG. 1 comprises a vehicle 110 that is identified by a VIN 120. Even though an exemplary car is illustrated in FIG. 1, the vehicle is not limited to a car. For example, the vehicle 110 may be a truck, a motorcycle, a bus, a boat, an airplane, etc. The vehicle 110 may comprise an on-board diagnostics (OBD) port 122. For example, the OBD port 122 may be an OBD II port having a specific connector pin layout for interfacing with external devices. For example, some of the connector pins of the OBD port 122 may be designated for data stream, ground and battery voltage. In other embodiments, the vehicle 110 could be another type of transportation device such as a bicycle.

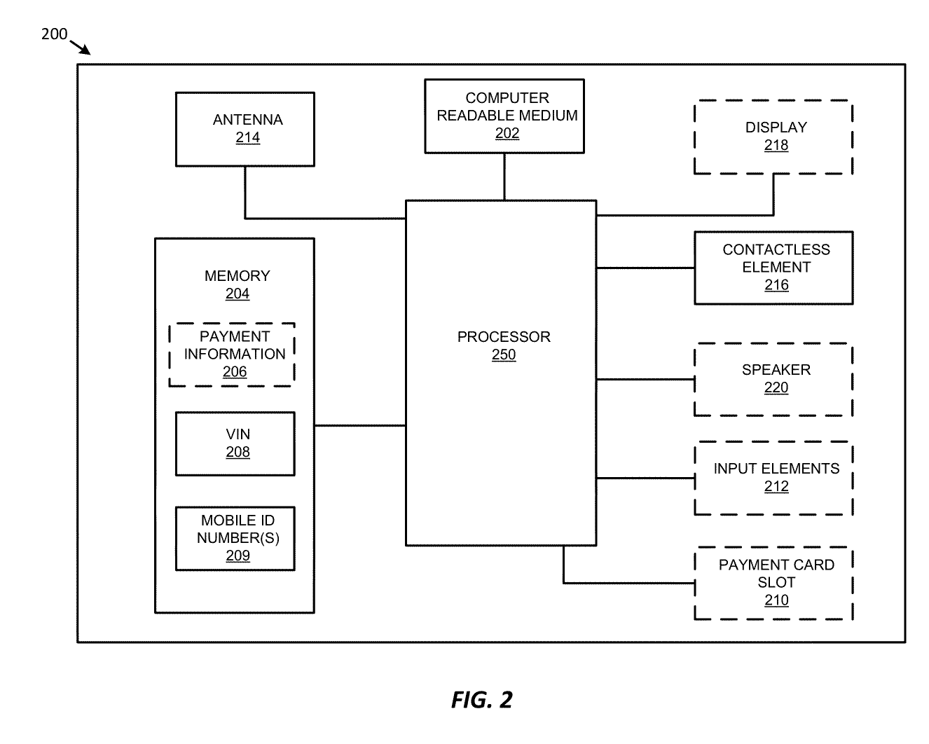

The system 100 may also include a VID 200 coupled to the vehicle 110. For example, the VID 200 may be connected to the OBD port 122 of the vehicle 110. In some embodiments, the VID 200 may be wirelessly coupled to the vehicle 110, such as via a Bluetooth connection or any other short range wireless communication. The VID is registered to the VIN 120 of the vehicle 110. In some embodiments, the VID may be registered with a plurality of vehicles of a same user. The VID may only be used in connection with the vehicle that the VID is registered with. The VID 200 may be used in conducting a payment transaction through the vehicle 110. Details of the VID are discussed below in greater detail in connection with FIG. 2.

The system 100 may also include a mobile communication device 130 provided within or in close proximity of the vehicle 110. In some embodiments, the mobile communication device 130 may be a mobile phone of the driver or one of the passengers of the vehicle 110. The mobile communication device 130 may be associated with a unique device number, such as an international mobile station equipment identity (IMEI) number. In addition, the mobile communication device 130 may also have a subscriber identification module (SIM) card which is associated with a unique serial number (i.e. integrated circuit card identifier (ICCI)) and a unique international mobile subscriber identity (IMSI). The mobile communication device 130 may be coupled to the vehicle 110 via a wired connection, such as through a USB port of the vehicle 110. Alternatively, the mobile communication device 130 may be coupled to the vehicle 110 via wireless connection, such as via Bluetooth.

In some embodiments, the mobile communication device 130 may be coupled to the vehicle 110 and the VID 200 via Bluetooth. For example, the mobile communication device 130 may have be equipped with a multipoint feature that allows the mobile communication device 130 to be paired with and simultaneously connect to (i.e. maintain active connection with) multiple devices, e.g. the vehicle 110 and the VID 200. In some embodiments, for example if the mobile communication device 130 does not support Bluetooth connection to multiple devices at the same time, the mobile communication device 130 may be coupled to the vehicle 110 via a wired connection, such as through a USB port, and the mobile communication device 130 may be coupled to the VID 200 via Bluetooth connection. One of ordinary skill in the art will appreciate that any combination of the wired or wireless connections may be used to couple the mobile communication device 130, the VID 200 and the vehicle 110.

During a payment transaction, a merchant access device may request payment account information from the VID 200. Prior to providing the payment account information to the merchant access device, the VID 200 may confirm that the VIN 120 of the vehicle 110 is registered with the VID 200 and that an approved mobile communication device 130 is within or in close proximity of the vehicle 110. The VID 200 may confirm that the mobile communication device 130 is within or in close proximity of the vehicle 110 by identifying the IMEI number of the mobile communication device 130, the ICCI number or the IMSI number of the SIM card coupled to the mobile communication device 130. The VID 200 may then compare the identified identification number of the mobile communication device 130 to one or more identification numbers of approved mobile communication devices stored by the VID 200. If the identified identification number of the mobile communication device 130 matches one of the stored identification number(s), the VID may determine that the mobile communication device 130 is located within or in close proximity of the vehicle 110.

The mobile communication device 130 may be in communication with the VID 200 via short range communication such as near field communications (NFC), Bluetooth connection, peer-to-peer WiFi connection or other suitable means of communication such as a universal serial bus (USB) connection. Thus, the VID 200 may retrieve the identification number of the mobile communication device 130 via any of the foregoing communication methods.

Referring now to FIG. 2, components of an exemplary VID 200 will be described below. Although some of the components may be depicted as separate, in some instances, one or more of the components may be combined into a single device or location. Similarly, although certain functionality may be described as being performed by a single component within the VID 200, the functionality may in some instances be performed by multiple components. Communication between entities and components may comprise the exchange of data or information using electronic messages and any suitable electronic communication medium and method, as described below.

The VID 200 may be located inside a vehicle 110 and near the OBD port 122, under the hood, on the dashboard, or in any other suitable location. The VID 200 may comprise a computer readable medium 202 that may be present within the body (or outer casing) of the VID 200. Alternatively, the computer readable medium 202 could be detachable from the VID 200. For example, the computer readable medium 202 could comprise an external memory that could be connected through a physical interface such as a USB connection, or the data could be hosted remotely and accessed wirelessly by the VID 200—e.g. the data could be hosted and stored at a remoter server in the “cloud”. The computer readable medium 202 may be in the form of a memory that stores data.

In addition to the computer readable medium 202, the VID 200 may include a separate memory 204 that may store information such as payment account information 206, vehicle information such as VIN 208 of vehicle(s) registered with VID 200, mobile identification numbers of approved mobile communication devices 209, access information (e.g., access badges), serial numbers, and any other suitable information. The payment account information 206 may include identification information associated with one or more payment accounts.

In some embodiments, the payment account information 206 may not be stored in the memory 204. A payment device, e.g. a payment card, may be coupled to (or embedded in) the VID 200 via an input port, such as a payment card slot 210. The VID 200 may read the payment account information 206 from the payment card slot 210. Alternatively, the payment account information 206 may be provided to the VID 200 by a user using, for example, input elements 212 of the VID 200. For example, the input elements 212 may include a keyboard for the user to enter the payment account information such as the PAN, the expiration date, CVV, etc. In various embodiments, the VID 200 may store the received payment account information at the memory 204.

In general, any of the information stored in the computer readable medium 202 or the memory 204 may be transmitted by the VID 200 to a merchant access device via any suitable method, including the use of an antenna 214 or a contactless element 216. The contactless element 216 may be implemented in the form of a semiconductor chip (or other data storage element) with an associated wireless transfer (e.g., data transmission) element, such as the antenna 214 or a separate dedicated antenna. In some embodiments, the contactless element 216 may be implemented in the form of an RFID unit to wirelessly transfer data to a merchant access device.

Data or control instructions that are transmitted to the VID 200 may be applied to the contactless element 36(g) by means of a contactless element interface (not shown). The contactless element interface functions to permit the exchange of data and/or control instructions between the VID 200 and another device having a contactless element (e.g. a merchant access device, a point of sales (POS) terminal or a payment device). Contactless element 216 may be capable of transferring and receiving data using a short range wireless communication capability.

VID 200 may also include a display 218 to allow a user to see payment account numbers and other information. In some embodiments, the VID 200 may be coupled to a display device of the vehicle to which the VID is connected. VID 200 may provide information to the vehicle to be displayed on the display device. The VID 200 may further include a speaker 220 to notify the user of the actions taken by the VID 200. For example, the VID 200 may announce the payment amount to the user via the speaker 220. Alternatively, if an object (the payment information, the mobile device, the VIN of the vehicle, etc.) is missing, the VID 200 may inform the user via the speaker 220.

The VID 200 may include a processor 250 (e.g., a microprocessor) for performing any of the functions described above. As provided above, VID 200 may receive a request for payment account information from a merchant access device and, upon performing the above-described security steps, may provide the payment account information to the merchant access device. Thus, the VID 200 may comprise components to both be the interrogator device (e.g. receiving data) and the interrogated device (e.g. sending data). Thus, the VID 200 may be capable of communicating and transferring data or control instructions via any suitable wireless network—e.g. the Internet or other data network and via short range communications.

### II. Payment Transaction Using a Vehicle Interface Device

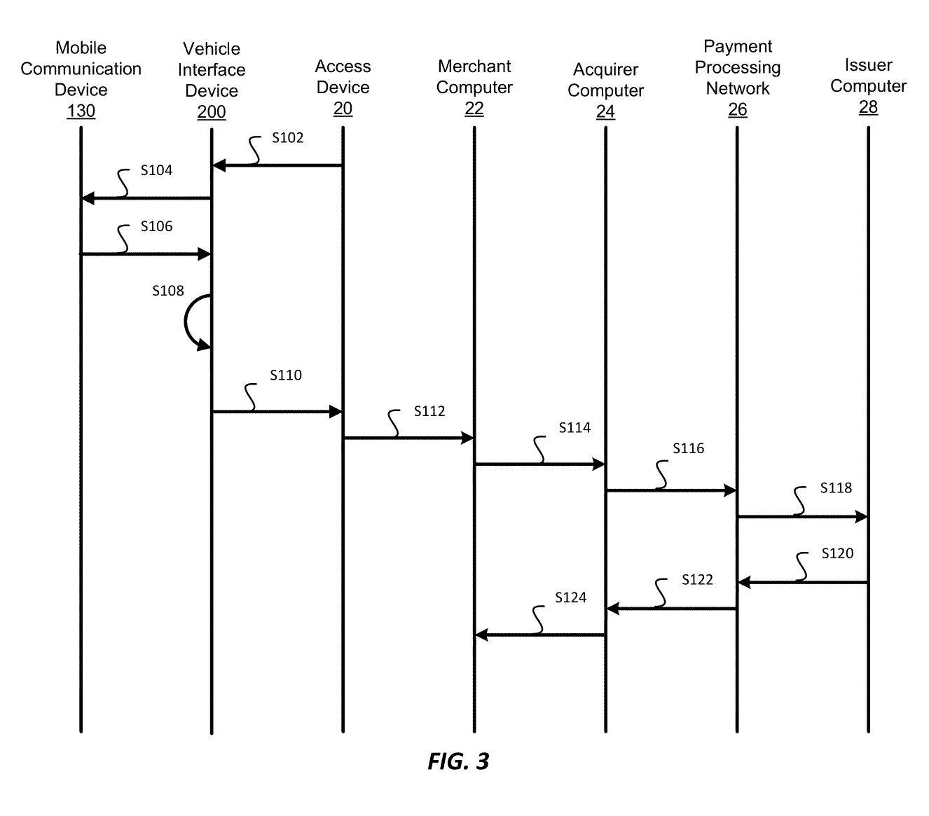

FIG. 3 is a flowchart illustrating methods according to embodiments of the invention. The VID 200 may be in communication with any nearby external device that can consume or request payment information for goods and/or services. The external device may be a merchant access device 20 such as a POS terminal, a parking meter, a toll booth, or some other external device. The merchant access device 20 and the VID 200 may communicate through wireless short range communication such as RFID, Bluetooth, infra-red, NFC, DSRC, etc. The merchant access device 20 may be in communication with and operatively coupled to an acquirer computer 24 via a merchant computer 22. The acquirer computer 24 may be associated with an acquirer processor. The acquirer computer 24 may in communication with and operatively coupled to a payment processing network 26. The payment processing network 26 may be operatively coupled to and in communication with an issuer computer 28.

Each of the acquirer computer 24, the payment processing network 26 and the issuer computer 28 may comprise a server computer. The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A user (not shown) may be operating or located within the vehicle 110, conducting a transaction, and in possession of a VID 200. In step S102, the VID 200 may receive a request for a payment from the merchant access device 20. The request message may include transaction information as well as a request for payment account information 206. For example, the merchant access device 20 may be at a fast food restaurant drive-through window, and the request message may include a transaction amount for the purchase of selected fast food items. In some embodiments, the merchant access device 20 may be at a gas station, and the request message may include a transaction amount for the purchase of gas. Other exemplary uses may include toll payment and in-vehicle shopping.

In some embodiments, the VID 200 may confirm that the mobile communication device 130 is located within the vehicle 110 and the VID 200 is coupled to the vehicle 110 before being operable to receive the request from the merchant access device 20. Once the collocation of the three devices is confirmed, the VID 200 may be activated and operable to receive the request.

The VID 200 may have access to the payment account information 206. For example, as discussed above in connection with FIG. 2, the payment account information 206 may be stored at a memory of the VID 200. Alternatively, the VID 200 may read the payment account information 206 from a payment device coupled to an input port of the VID 200.

In step S104, the VID 200 may confirm that a certain mobile communication device 130 is located inside or within close proximity of the vehicle 110. The VID 200 may do this by identifying the SIM card number, the IMEI number, the phone number or any other mobile device identifier of the mobile communication device 130. The VID 200 may compare the identified identification number of the mobile communication device 130 to one or more identification numbers of approved mobile communication devices stored by the VID 200. If the identified identification number of the mobile communication device 130 matches one of the stored identification number(s), the VID may determine that the mobile communication device 130 is located within or in close proximity of the vehicle 110. As shown in step S106, the mobile communication device 130 may be in communication with the VID 200 via short range communication such as NFC, Bluetooth, peer-to-peer WiFi or other suitable means of communication such as USB. If the VID 200 (i.e. the processor 250 of the VID 200) confirms that the certain mobile communication device 130 is located inside the vehicle 110, it may proceed to step S108.

If the VID 200 determines that the mobile communication device 130 is not located inside or near the vehicle, the VID 200 may deny the request for payment account information from the merchant access device 20. For example, the VID 200 may only work when paired with the mobile communication device 130. The VID 200 may function and communicate with the merchant access device 20 when the mobile communication device 130 is present, and then become disabled when the mobile communication device 130 moves away from the vehicle 110. In some embodiments, the user may be able to use the mobile communication device 130 to manually disable the VID 200. Also, in some embodiments, the VID 200 and the mobile communication device 130 may be a single device.

In step S108, the VID 200 may confirm that the VID 200 is located inside a certain vehicle 110. The VID 200 may be registered to function only when coupled to a vehicle 110 with a specific VIN 120 (or other vehicle identifier). For example, the VID 200 may only work if the VIN 120 matches the one entered when registering the VID 200. Alternatively, the user may contact a payment processing network or issuer to register a VIN 120 with the VID 200. The VID 200 may be capable to have multiple registered VINs 120.

The VID 200 may be coupled to the vehicle 110 and thereby capable to identify the VIN 120 of the vehicle 110. The coupling may comprise a connection between the VID 200 and the vehicle 110 through, for example, the OBD port 122 of the vehicle 110. Further, the processor of the VID 200 may be programmed such that VID 200 will only operate when coupled to the vehicle 110 that is identified by the specific VIN 112 that is registered with the VID 200.

If the VID 200 confirms that the VID 200 is located inside the correct vehicle 110, the method may proceed to step S110. If the VID 200 determines that the VID 200 is not located inside or near the correct vehicle 110, the VID 200 may deny the request for payment account information from the merchant access device 20.

If the VID 200 confirms that the mobile communication device 130 is within or near the vehicle 110 and that the VID 200 is coupled to the correct vehicle 110, at step S110 the VID 200 may transmit the payment account information to the merchant access device 20 via short range communications, e.g. using an RFID unit.

In some embodiments, the VID 200 may transmit the request for payment account information to the mobile communication device 130. The user may observe the received request on the mobile communication device 130 and may choose to allow or deny the purchase. The request may be presented to the user via a mobile wallet application on the mobile communication device 130. The mobile wallet application may be in communication with a payment processing network 26 and/or issuer 28. The user may have multiple payment accounts registered with the mobile wallet application, and the user may be able to select which account to use for the transaction. If the user chooses to allow the transaction, the mobile wallet application may generate a token for the transaction, or receive a token from the payment processing network 26 or issuer 28. The mobile communication device 130 may transmit the token to the VID 200, which may then transmit the token, instead of the payment account information, to the merchant access device 20. If the user chooses to deny the transaction, the mobile communication device 130 may deny transmission of the token to the VID 200, which in turn may deny the transmission of the token and payment account information to the merchant access device 20.

In some embodiments, the user may anticipate a future transaction, generate the token, and/or transmit the token to the VID 200 before receiving the request for payment account information from the merchant access device 20. The token may be valid and functioning for a limited amount of time, such as 5 minutes, and/or may only be valid for the transaction specified in the request. Further, the token may limit the amount that can be charged and/or the specific merchant or merchant type authorized to redeem the token. The token may be a one-time token that expires once redeemed.

Upon receiving the payment account information from the VID 200, the merchant access device 20 may send an authorization request message comprising the payment account information to the acquirer computer 24 via a corresponding merchant computer 22 (steps S112 and S114). The acquirer computer 24 may send the message to the payment processing network 26 (step S116), which may in turn authorize the request with the issuer computer 28 (step S118). The issuer computer 28 may respond with an authorization response message (step S120). After sending the authorization request message, the merchant computer 22 may receive the authorization response message indicating that the transaction is authorized via the acquirer computer 24 (steps S122 and S124). The merchant may release the goods and/or services to the user.

### III. Methods for Using a Vehicle Interface Device

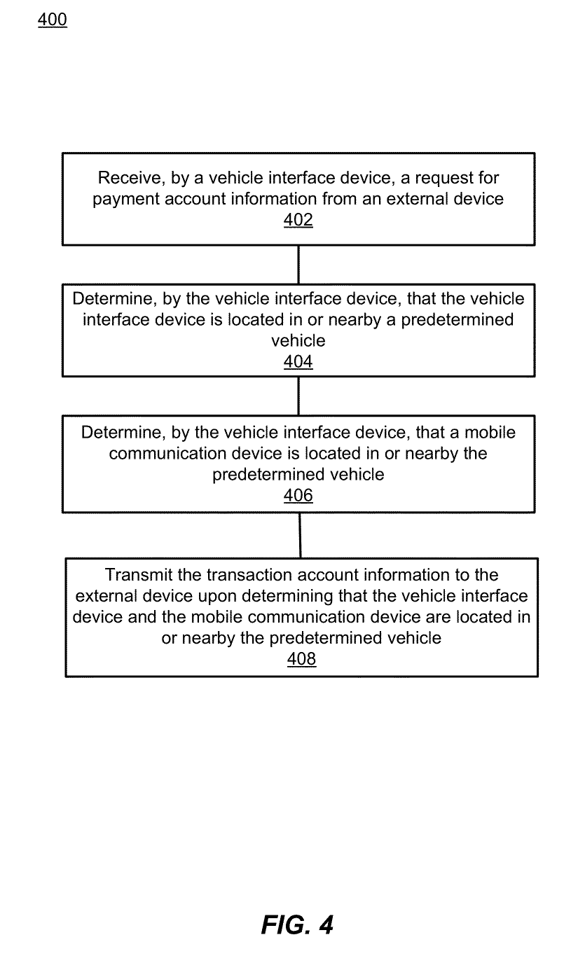

As provided above, a VID coupled to a vehicle may be used to conduct a payment transaction. When the VID is in a pre-determined proximity of a merchant access device, such as a merchant POS terminal, the merchant access device may send a message to the VID requesting payment account information to be used for payment for the goods or services offered by the merchant. FIG. 4 shows a flowchart of a method 400 for transmitting payment information using a VID based on the presence of a mobile device and a VIN registered with the VID, according to an exemplary embodiment.

At step 402, a request for payment account information from an external device is received at a vehicle interface device (VID). As provided above, when the VID is in a pre-determined proximity of the merchant access device, the merchant access device may send a message to the VID requesting payment account information to be used for payment for the goods or services offered by the merchant. In various embodiments, the VID may communicate with the external device via short range contact or contactless communication capability.

At step 404, the VID may determine that the vehicle interface device is located in or nearby a predetermined vehicle. For example, the VID may have been registered with a vehicle identification number (VIN) associated with the predetermined vehicle. The VID may retrieve the VIN of the vehicle in which the VID is provided. The VID may then compare the retrieved VIN to the VIN registered with (i.e. stored at) the VID. If the retrieved VIN matches the stored VIN, the VID may determine that the VID is located in the predetermined (i.e. correct) vehicle.

At step 406, the VID may determine that a mobile communication device is located in or nearby the predetermined vehicle as well. The VID may retrieve an identification number, such as phone number, a SIM card number or an IMEI number of the mobile device. For example, the identification number of approved mobile communication devices may be stored by the VID. Upon retrieving the identification number of the mobile communication device, the VID may compare the retrieved identification number to the stored (i.e. approved) identification numbers. If the retrieved identification number matches the stored identification number, the VID may determine that the mobile communication device is located in the predetermined (i.e. correct) vehicle.

At step 408, the VID may transmit the transaction account information to the external device upon determining that the vehicle interface device and the mobile communication device are located in or nearby the predetermined vehicle. In some embodiments, the transaction account number may be stored in the VID. For example, the transaction account information may be among a plurality of transaction accounts stored in the vehicle interface device. In this case, the VID may select the transaction account among the stored plurality of transaction accounts based on, for example, a voice authorization command from a user. Alternatively, the VID may acquire the transaction account information from a payment device. According to various embodiments, the transaction account information may be associated with a credit card account, a bank account, a checking account, a savings account, a prepaid account, a reward points account or an airline miles account.

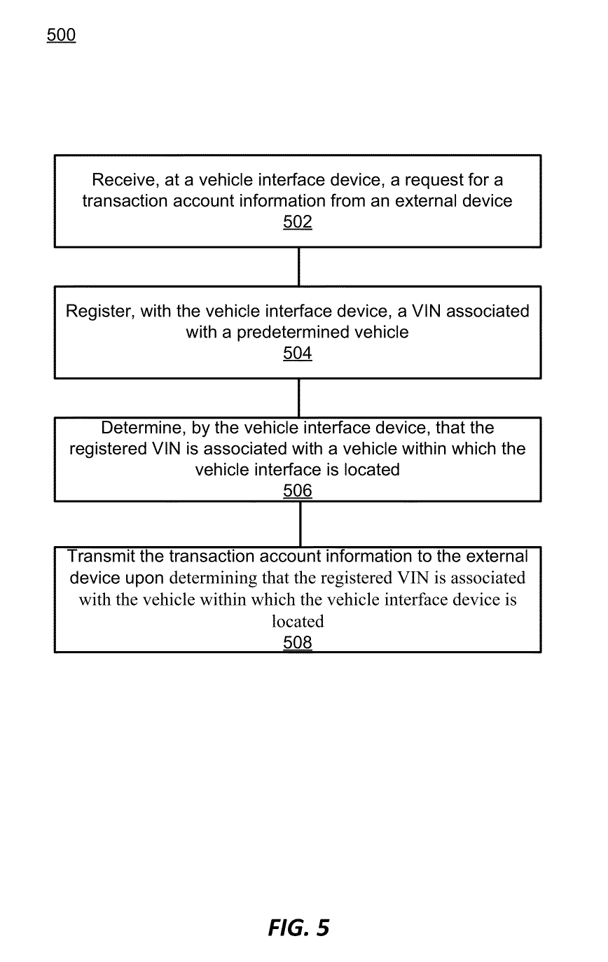

In some embodiments, the VID may transmit the transaction account information to a merchant upon confirming that a VIN registered with the VID matches the VIN of a vehicle within which the VID is located. As provided above, when the VID is in a pre-determined proximity of a merchant access device, such as a merchant POS terminal, the merchant access device may send a message to the VID requesting payment account information to be used for payment for the goods or services offered by the merchant. FIG. 5 shows a flowchart of a method 500 for transmitting transaction account information from the VID based on the verification of a VIN, according to another exemplary embodiment.

At step 502, a request for payment account information from an external device is received at a VID. As provided above, when the VID is in a pre-determined proximity of the merchant access device, the merchant access device may send a message to the VID requesting payment account information to be used for payment for the goods or services offered by the merchant. In various embodiments, the VID may communicate with the external device via short range contact or contactless communication capability.

At step 504, a vehicle identification number (VIN) associated with a predetermined vehicle may be registered with the VID. The VID may store the registered VIN at a memory.

At step 506, the VID may determine that the registered VIN is associated with a vehicle within which the vehicle interface device is located. For example, the VID may retrieve the VIN of the vehicle in which the VID is located. The VID may then compare the retrieved VIN to the VIN registered with (i.e. stored at) the VID. If the retrieved VIN matches the stored VIN, the VID may determine that the VID is located in the predetermined (i.e. correct) vehicle.

At step 508, the VID may transmit the transaction account information to the external device upon determining that the registered VIN is associated with the vehicle within which the vehicle interface device is located. In some embodiments, the transaction account number may be stored in the VID. For example, the transaction account information may be among a plurality of transaction accounts stored in the vehicle interface device. In this case, the VID may select the transaction account among the stored plurality of transaction accounts based on, for example, a voice authorization command from a user. Alternatively, the VID may acquire the transaction account information from a payment device. According to various embodiments, the transaction account information may be associated with a credit card account, a bank account, a checking account, a savings account, a prepaid account, a reward points account or an airline miles account.

Embodiments of the invention have a number of advantages. For example, some embodiments provide a three-factor security system by requiring both a specific mobile communication device 130 and a specific vehicle 110 with a specific VIN 120 to be present to operate the VID 200. It is unlikely that a purchase made using all three objects would be fraudulent. For example, if the VID 200 were stolen it would not operable to make purchases unless the vehicle 110 and mobile communication device 130 were also stolen together. Further, the user is able to make purchases without having to leave the car or handing anything out of the car. For example, the user would not need to pass a payment device or the VID 200 to a merchant, and thereby the risk of unauthorized copying of payment account information is reduced and convenience is increased. Additionally, users can conduct transactions while driving. For example, a user may pay a toll fee without having to stop at a toll booth and physically hand over cash or a payment device, but can instead pay via the VID 200 and pass through the toll area without stopping.

Further, the system comprises a seamless authentication. The colocation of the VID 200, the vehicle 110 with a specific VIN 112, and the mobile communication device 130 is enough for the system to function. The user may not need to re-enter payment account information, a one-time password, the VIN for each transaction, or otherwise perform any activity to achieve three factor security beside simply possessing the three coupled devices. As most users will constantly be in possession of their mobile communication device 130, and a vehicle 110 is present when driving, it is convenient for these devices to be security factors. The mobile communication device 130 is further advantageous in that the mobile communication device 130 may be capable to authorize purchases before sending the token to the VID 200 and the external device or the merchant.

A mobile wallet on the mobile communication device 130 may be obtain a pre-authorized token, such that a merchant only needs to redeem the token instead of going through all the usual steps of authorization, allowing faster, more secure, and more convenient transactions. Also, the mobile communication device 130 may be capable to provide geolocational data which may be useful for applications such as tracking spending trends. The mobile communication device 130 may be additionally capable to provide risk data which may be useful for applications such as blocking potentially fraudulent purchases. For example, transactions being attempted at a merchant type rarely visited by the user or in a location unfamiliar to the user may be blocked as potentially fraudulent.

### IV. Additional Exemplary System Embodiments

Provided below is a description of an exemplary system in which embodiments provided herein may be utilized. Although some of the entities and components may be depicted as separate, in some instances, one or more of the components may be combined into a single device or location (and vice versa). Similarly, although certain functionality may be described as being performed by a single entity or component within the system, the functionality may in some instances be performed by multiple components and/or entities (and vice versa). Communication between entities and components may comprise the exchange of data or information using electronic messages and any suitable electronic communication medium and method, as described below.

As used herein, an “issuer” may typically refer to a business entity (e.g., a bank or other financial institution) that maintains financial accounts for the user and often issues a payment device such as a credit card to the user. As used herein, a “merchant” may typically refer to an entity that engages in transactions and can sell goods or services to the user. As used herein, an “acquirer” may typically refer to a business entity (e.g., a commercial bank or financial institution) that has a business relationship with a particular merchant or similar entity. Some entities can perform both issuer and acquirer functions.

An exemplary financial transaction system is shown in FIG. 6. The system 600 may include one or more merchants, one or more access devices 34, one or more acquirers, and one or more issuers. For example, the system 600 may include a merchant having a merchant computer 22 that comprises an external communication interface (e.g., for communicating with an access device 20 and an acquirer 24), system memory comprising one or modules to generate and utilize electronic messages, and a data processor (for facilitating a financial transaction and the exchange of electronic messages); an acquirer having an acquirer computer 24 that comprises an external communication interface (e.g. for communicating with a merchant computer 22 and a payment processing network 26), system memory comprising one or modules to generate and utilize electronic messages, and a data processor (for facilitating a financial transaction and the exchange of electronic messages); and an issuer having an issuer computer 28 that comprises an external communication interface (e.g. for communicating with a payment processing network 26), system memory comprising one or modules to generate and utilize electronic messages, and a data processor (for facilitating a financial transaction and the exchange of electronic messages). The external communication interface of the merchant computer 22 may be coupled to an access device 20 (such that information may be received by the access device 20 and communicated to the merchant computer 22) or, in some embodiments, the access device 20 may comprise a component of the merchant computer 22.

As used in this context, an external communication interface may refer to any hardware and/or software that enables data to be transferred between two or components of system 600 (e.g., between devices residing at locations such as an issuer, acquirer, merchant, payment processing network, etc.). Some examples of external communication interfaces may include a modem, a network interface (such as an Ethernet card), a communications port, a Personal Computer Memory Card International Association (PCMCIA) slot and card, or the like. Data transferred via external communications interface may be in the form of signals which may be electrical, electromagnetic, optical, or any other signal capable of being received by the external communications interface (collectively referred to as “electronic signals” or “electronic messages”). These electronic messages that may comprise data or instructions may be provided between one or more of the external communications interface via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable method.

Any suitable communications protocol for storing, representing, and transmitting data between components in the system 600 may be used. Some examples of such methods may include utilizing predefined and static fields (such as in core TCP/IP protocols); “Field: Value” pairs (e.g., HTTP, FTP, SMTP, POP3, and SIP); an XML based format; and/or Tag-Length-Value format.

As shown in the exemplary system 600 in FIG. 6, payment information 206 may be provided to the access device 20 by a VID 200. Prior to providing the payment information 206, the VID 200 may confirm that the VID 200 is coupled to a correct vehicle 110 based on the VIN of the vehicle 110. For example, VID 200 may confirm that the VIN of the vehicle 110 is registered with the VID 200. The VID 200 may also confirm that a mobile communication device 130 is provided within or near the vehicle 110. Accordingly, the VID 200 may be in communication with the vehicle 110 and the mobile communication device 130 via, for example, short range communication methods.

In some embodiments, a first communications channel, such as an Internet Protocol Gateway (IPG) 27, may be in operative communication with the payment processing network 26. Although the IPG 27 is shown as being a separate entity in FIG. 6, the IPG 27 could be incorporated into the payment processing network 26, or could be omitted from the system 600. In the latter situation, the first communications channel could directly connect the payment processing network 26 and the user computer or mobile device. In general, providing communication from the user to the payment processing network or other entity may enable a variety of increased functionalities to the user, such as advanced authentication and verification methods (particularly in e-commerce and similar transactions), examples of which are described in U.S. Ser. No. 12/712,148 filed on Jul. 16, 2010 and U.S. Ser. No. 13/184,080 filed on Jul. 15, 2011, each of which is incorporated by reference herein in its entirety.

In some embodiments, an electronic or digital wallet (i.e., “e-Wallet”) may be utilized as a payment device for conducting a financial transaction. As shown in FIG. 6, such exemplary systems may comprise an electronic wallet server 29, which may be in operational communication with a merchant and/or with a payment processing network 26 (or in some embodiments, the electronic wallet server 29 may comprise a part of the payment processing network 26). The electronic wallet server 29 may be programmed or configured to provide some or all of the functionality associated with conducting transactions using an electronic wallet, including maintaining an association between the user's E-wallet and one or more payment accounts (such as a bank account or credit card account) in the E-Wallet database 31. To provide electronic wallet services (i.e. the use of the electronic wallet associated with a payment account to conduct a financial transaction), the electronic wallet server 29 may further provide a web interface (e.g. through one or more web pages) to receive and transmit requests for payments services and/or may provide an application program interface (API) (shown as electronic wallet client 37) at the mobile communication device 130 to provide the web service. This process is described in more detail in U.S. Application No. 61/466,409 filed on Mar. 22, 2011, which is incorporated herein by reference in its entirety.

As noted above, the user's electronic wallet may be stored in the E-Wallet database 31, which may include information associated with the user's payment accounts, and can be used in conducting a financial transaction with a merchant. For example, the E-Wallet database 31 may include the primary account numbers of one or more payment accounts (e.g., payment accounts associated with a credit card) of the user. The E-wallet may be populated with such information during an initial enrollment process in which the user enters information regarding one or more of the payment accounts that may be associated with various issuers. Once the payment account information is added to the E-Wallet database 31, the user may perform transactions by utilizing only his E-wallet. When a user performs a transaction using his electronic wallet, the user need not provide the merchant with payment account information, but may instead provide the electronic wallet information. This information may then be included in an authorization request message, which in turn may be provided to payment processing network 26. The payment processing network 26 may then access the user's E-wallet via a request to the electronic wallet server 29, or may have direct access to the E-wallet database 31 so as to obtain the corresponding payment account information indicated by the information in the authorization request message.

The electronic wallet client 37 may comprise any suitable software that provides front end functionality of the electronic wallet to the user. For example, the electronic wallet client 37 may be embodied as a software application downloadable by a computer apparatus or mobile device 130 (e.g., a mobile phone). In some instances, the electronic wallet client 37 may provide a user interface (such as a series of menus or other elements) that allows the user to manage his electronic wallet(s) (i.e. the electronic wallet client 37 may enable interaction with the electronic wallet server 29, and thereby the e-wallet database 31). In some embodiments, the electronic wallet client 37 may store data in a computer readable memory for later use, such as user preferences or identifiers associated with funding sources added to the electronic wallet.

A payment processing network 26 may be disposed between the acquirer computer 24 and the issuer computer 28 in the system 600. Furthermore, the merchant computer 22, the acquirer computer 24, the payment processing network 26, and the issuer computer 28 may all be in operative communication with each other (i.e., although not depicted in FIG. 6, one or more communication channels may exist between each of the entities, whether or not these channels are used in conducting a financial transaction).

The payment processing network 26 may include data processing subsystems, networks, and operations used to support and deliver authorization services, exception file services, and clearing and settlement services. For example, the payment processing network 26 may comprise a server computer, coupled to a network interface (e.g. by an external communication interface), and a database(s) of information. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 26 may use any suitable wired or wireless network, including the Internet.

### V. Exemplary Computer Apparatuses

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

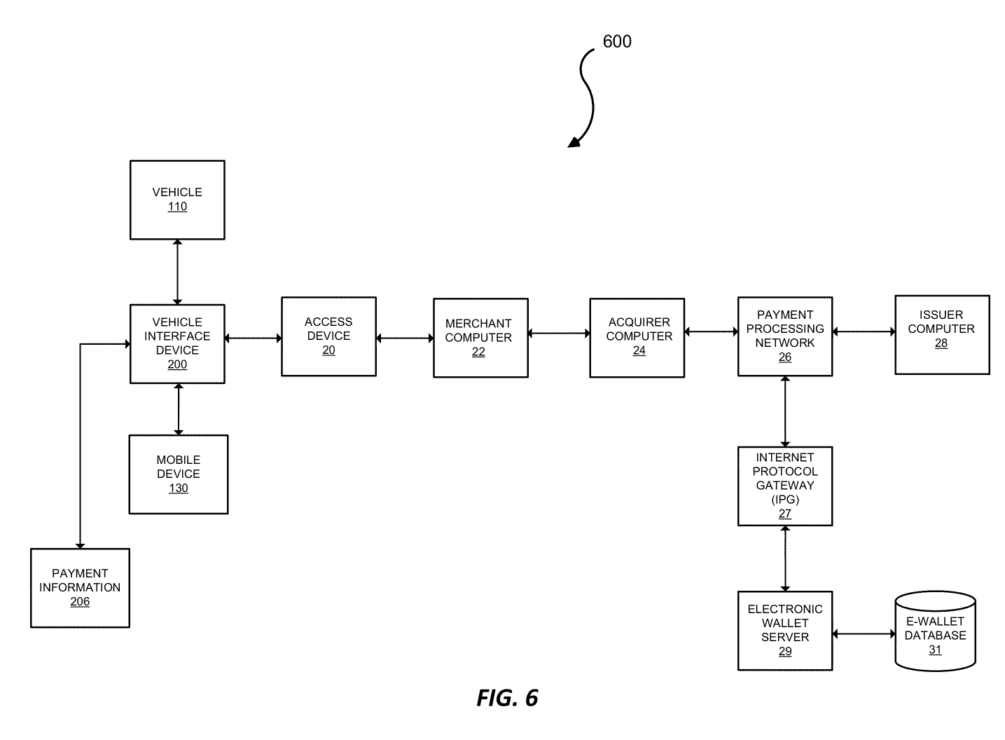

FIG. 7 shows some components in a computer apparatus. The computer apparatus may be used in any of the components illustrated in FIGS. 1, 2 and 6, and such components may use any suitable combination or number of subsystems shown in FIG. 7. The subsystems shown in FIG. 7 are interconnected via a system bus 775. Additional subsystems such as a printer 774, keyboard 778, fixed disk 779 (or other memory comprising computer readable media), monitor 776, which is coupled to display adapter 782, and others are shown. Peripherals and input/output (I/O) devices, which couple to I/O controller 771 (which can be a processor or other suitable controller), can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art. The scope of the invention should, therefore, be determined not with reference to the above description, but instead should be determined with reference to the pending claims along with their full scope or equivalents.

A recitation of “a,” “an,” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

All publications mentioned herein are incorporated herein by reference to disclose and describe the methods and/or materials in connection with which the publications are cited.

What is claimed is:

1. A method comprising:
receiving, at a vehicle interface device, a request for transaction account information from an external device;
determining, by the vehicle interface device, that the vehicle interface device is located in a predetermined vehicle;
determining, by the vehicle interface device, that a mobile communication device is located in the predetermined vehicle; and
transmitting the transaction account information to the external device upon determining that the vehicle interface device and the mobile communication device are located in the predetermined vehicle.

2. The method of claim 1 wherein the transaction account information is stored in the vehicle interface device.

3. The method of claim 1 further comprising:
acquiring the transaction account information from a payment device.

4. The method of claim 1 wherein the transaction account information is among a plurality of transaction accounts stored in the vehicle interface device.

5. The method of claim 1 further comprising:
selecting, by the vehicle interface device, the transaction account information based on a voice authorization command from a user.

6. The method of claim 1 wherein the transaction account information is associated with one or more of a credit card account, a bank account, a checking account, a savings account, a prepaid account, a reward points account and an airline miles account.

7. The method of claim 1 further comprising:
registering, with the vehicle interface device, a vehicle identification number (VIN) associated with the predetermined vehicle.

8. The method of claim 7 wherein the step of determining if the vehicle interface device is located within the predetermined vehicle further comprises:
confirming, by the vehicle interface device, that the registered VIN is associated with a vehicle within which the vehicle interface device is located.

9. The method of claim 1, wherein the vehicle interface device communicates with the external device via short range contact or contactless communication capability.

10. A vehicle interface device comprising:
a processor; and
a computer readable medium coupled to the processor, the computer readable medium comprising code that, when executed on the processor, causes the processor to:
receive a request for transaction account information from an external device;
determine that the vehicle interface device is located in a predetermined vehicle;
determine that a mobile communication device is located in the predetermined vehicle; and
transmit the transaction account information to the external device upon determining that the vehicle interface device and the mobile communication device are located in the predetermined vehicle.

11. The vehicle interface device of claim 10 wherein the transaction account information is stored in the vehicle interface device.

12. The vehicle interface device of claim 10 wherein the computer readable medium comprises code that, when executed on the processor, further causes the processor to:
acquire the transaction account information from a payment device.

13. The vehicle interface device of claim 10 wherein the transaction account information is among a plurality of transaction accounts stored in the vehicle interface device.

14. The vehicle interface device of claim 10 wherein the computer readable medium comprises code that, when executed on the processor, further causes the processor to:
select the transaction account information based on a voice authorization command from a user.

15. The vehicle interface device of claim 10 wherein the transaction account information is associated with one or more of a credit card account, a bank account, a checking account, a savings account, a prepaid account, a reward points account and an airline miles account.

16. The vehicle interface device of claim 10 wherein the computer readable medium comprises code that, when executed on the processor, further causes the processor to:
register, with the vehicle interface device, a vehicle identification number (VIN) associated with the predetermined vehicle.

17. The vehicle interface device of claim 16 wherein the computer readable medium comprises code that, when executed on the processor, further causes the processor to:
confirm that the registered VIN is associated with a vehicle within which the vehicle interface device is located.

18. The vehicle interface device of claim 10 wherein the vehicle interface device communicates with the external device via short range contact or contactless communication capability.

19. A method comprising:
receiving, at a vehicle interface device, a request for transaction account information from an external device;
registering, with the vehicle interface device, a vehicle identification number (VIN) associated with a predetermined vehicle;
determining, by the vehicle interface device, that the registered VIN is associated with a vehicle within which the vehicle interface device is located; and
transmitting a payment account information to the external device upon determining that the vehicle interface device is located in the predetermined vehicle.

20. The method of claim 19 further comprising:
determining, by the vehicle interface device and prior to transmitting the payment account information, that a mobile communication device is located in the predetermined vehicle.
